(19) United States
(12) Patent Application Publication
(10) Pub. No.: US 2004/0205749 A1
(43) Pub. Date: Oct. 14, 2004

(54) System for enabling application software of data acquisition devices

(75) Inventors: Bryan L. Dalton, Endicott, NY (US); Michael A. Heaton, Owego, NY (US)

Correspondence Address: TAROLLI, SUNDHEIM, COVELL & TUMMINO LLP, 526 Superior Avenue - Suite 1111, CLEVELAND, OH, 44114, US

(73) Assignee: Lockheed Martin Corporation

(21) Appl. No.: 10/809,008

(22) Filed: Mar. 25, 2004

Related U.S. Application Data
(60) Provisional application No. 60/457,617, filed on Mar. 26, 2003.

(51) Int. Cl. G06F 15/16

(52) U.S. Cl. 717/178

(57) ABSTRACT

A system enables a mobile data acquisition device. The system includes a software application for use with the mobile data acquisition device. The software application is located on a remote computer. The remote computer transfers the software application from the remote computer to the mobile data acquisition device. The remote computer installs and activates the software application for use by the mobile data acquisition device. The software application is determined by a user and replaces a factory default software application.

### FIELD OF INVENTION

The present invention relates to a system for enabling software, and more specifically, to a system for remotely enabling applications software for mobile devices.

### BACKGROUND OF THE INVENTION

A conventional data collection system may include a mobile unit utilizing applications software to collect and process data by a sequence of automated and/or manual operations. A typical automated process is the non-contact scanning of bar code data by means of a cyclically deflected laser beam or an image photosensor of the CCD type. Once a valid bar code reading has been obtained, a keypad may be manually operated to indicate an associated quantity. The user may then manually initiate a further operation, for example, the on-line transmission of the data to a remote host computer by a known means such as a radio frequency communications link.

### SUMMARY OF THE INVENTION

A system in accordance with the present invention enables a mobile data acquisition device. The system includes a software application for use with the mobile data acquisition device. The software application is located on a remote computer. The remote computer transfers the software application from the remote computer to the mobile data acquisition device. The remote computer installs and activates the software application for use by the mobile data acquisition device. The software application is determined by a user and replaces a factory default software application.

Another system in accordance with the present invention enables a software application. The system includes a data acquisition device and a remote computer. The data acquisition device is used with the software application. The remote computer transmits the software application from the remote computer to the data acquisition device. The remote computer installs and activates the software application for use by the data acquisition device. The data acquisition device has the capability of disabling the software application of the data acquisition device.

A computer program product in accordance with the present invention enables a software application. The computer program product includes: a first instruction for initiating communication between a mobile device and a remote computer; a second instruction for requesting the state of the mobile device by the remote computer; a third instruction for responding to the remote computer by the mobile device with a factory default state message; a fourth instruction for initiating transfer of a software application from the remote computer to the mobile device; and a fifth instruction for acknowledging receipt of the software application from the remote computer by the mobile device thereby enabling the software application at the mobile device.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of an example system in accordance with the present invention;

FIG. 2 is a schematic representation of another example system in accordance with the present invention; and

FIGS. 3A and 3B are a schematic representation of still another example system in accordance with the present invention.

### DESCRIPTION OF AN EXAMPLE EMBODIMENT

A system in accordance with the present invention may enable software applications on a deployed fleet of mobile devices. The mobile devices may be shipped in a factory default condition. The software applications may be selected based on user role and/or individual user selection. The system may perform several enabling functions: 1) the selection of an application by a user; 2) the transmission of the selected application from a remote computer; and/or 3) the installation/activation of the application.

The system may provide a simple, flexible selection and loading of application software onto a mobile device subsequent to the mobile device being deployed at a customer site. The system may also provide the capability to enable new applications, as the new applications become available, and to disable applications that are no longer required. The system may provide complete flexibility in selecting applications that are required for each site's/user's business needs; and further may allow a straightforward manufacturing, kitting, and deployment process to be implemented with no predetermined software customization requirements.

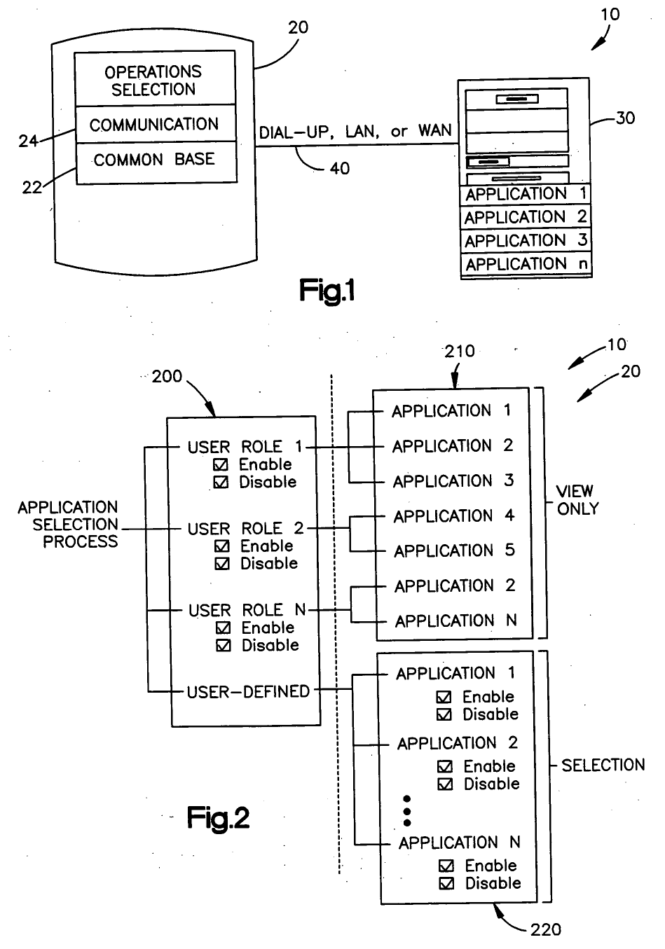

An example system 10 in accordance with the present invention selectively enables applications software on a fleet of deployed, mobile, data acquisition devices 20 for a business or company (FIG. 1). The example system 10 provides the capability to select the application(s) of interest, upon which the applications software may be downloaded, installed, and/or activated.

The applications software may be centrally managed on, and downloaded from, a remote computer 30. Each mobile device 20 may be located at a specific business site and communicate with the remote computer 30 over a dial-up, LAN, or WAN connection 40.

The example system 10 may support a field deployment strategy in which all mobile devices 20 may be shipped in a factory default state and customized with applications software at the site. The system 10 may provide the capability of individually enabling each mobile device 20 with the applications that are needed to support a diverse work force with varying roles and job responsibilities. The system 10 may further provide simple and intuitive applications selection. The system 10 may still further provide flexible enablement of new applications or disablement of existing applications over time. The system 10 may yet further provide centrally located control for application updates and application management from the remote computer 30.

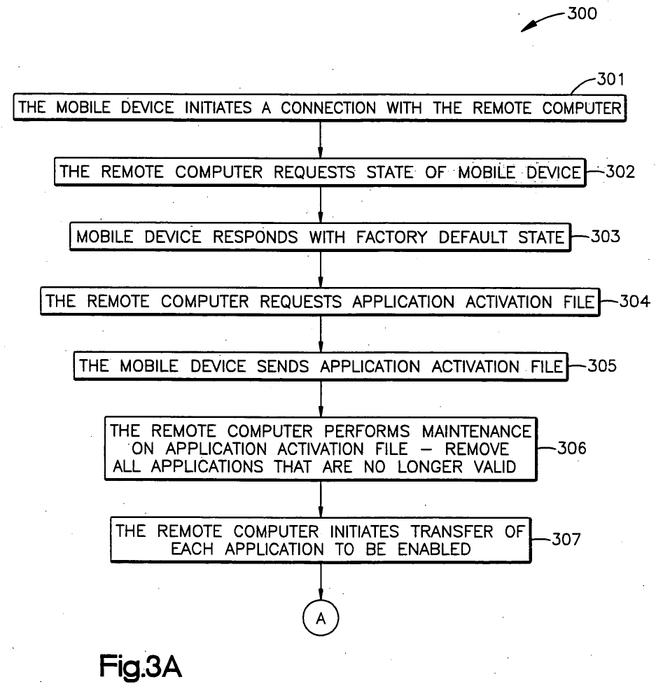

Each mobile device 20 may be built and subsequently deployed in the field in a factory default state. This condition enables the mobile device 20 to select applications to enable and connect to the remote computer 30 thereby accessing the enabled software for selected end-user applications (FIG. 2).

An application selection module 220 of the mobile device 20 may allow a user to enable/disable applications of varied operations for the user. The functions and methods that support a base level of service for interacting with a mobile device 20 may be provided by a common base application 22 of the mobile device (FIG. 1). All end-user applications may depend on the capabilities provided by the common base application 22. Functions and protocols for establishing a connection with the remote computer 30 and performing necessary handshaking may be provided in a communications application 24 of the mobile device 20.

A list of available end-user applications available at the time of deployment may be provided in an application list module 210 on each mobile device 20 in a factory default state (FIG. 2). Systematic updates of the list, over time, may occur as new applications are made available or old applications are replaced/discarded. The application list module 210 may describe applications that are available at any given time.

Each entry in the application list module 210 may represent a single, unique application. A set of attributes may be provided to identify and characterize each application entry. The format of each of the following example entries may consist of text fields that are delimited with a graphical character. Application ID may be a unique value that identifies the application. Application Name may be a common name of the application for display. Application Version may be a version number of the application. User Role may be the role(s) of the user to which the application applies. Application Date may be the date of creation or last update of the application. Description may be a brief description of the purpose of the application.

The tasks that a user performs may be determined by the user's job title and associated responsibilities. A user typically performs multiple tasks as part of her/his job. User Role provides a categorical approach to grouping tasks by job responsibility. There may be a one-to-many relationship between each application and User Role assuming that different user types may require the same application. User Role may be selected in a User Role Selection Module 200.

When the mobile device 20 detects that the mobile device is in a factory default state, the mobile device may present a graphical user interface (GUI) menu selection tree to the user through the User Role Selection Module 200. The menu may display a list of User Roles specified. User Roles may be listed in alphanumeric order. An example format for a selection tree is described below (FIG. 2).

User Role may simplify the application selection process in that a user only need select her/his role to enable an appropriate application or applications, rather than individually selecting each application. A list of each application in the Application List Module 210 and a description may be displayed when the menu is expanded (FIG. 2). This allows a user to view the list of applications that apply to a specific User Role and which will be installed if that User Role is selected in the User Role Selection Module 200.

The system 10 may further provide an accommodation for special users who may not fit a pre-defined User Role. A “User-Defined” category in the User Role Selection Module 200 may allow these special users to view the entire list (i.e., Applications 1-N) of available applications from the Application List Module 210. Unlike application lists presented for each User Role, the entries in the applications list for the “User-Defined” category may be specifically selected for enablement individually.

The system 10 may also disable an application in the same way. A user may disable all applications for a selected User Role in the User Role Selection Module 200 or individual applications under the “User-Defined” category (FIG. 2).

The application selection process of the system 10 may result in the creation of an applications activation file. This file may include the list of each application that should be enabled (or disabled) on a mobile device 20. If a particular User Role has been selected in the User Role Selection Module 200, then all applications applicable to the selected User Role may be listed in this file. If the “User-Defined” User Role has been selected, then those applications that were individually chosen may be listed in this file.

Each User Role entry may consist of the following information. Application ID may be a unique value that identifies the application. Application Name may be the common name of the application, for display. Application Version may be the version number of the application. Application Date may be the date of creation or last update of the application. Date of Activation may be the current date. Action may be the action to be performed, which includes ‘E’ to enable the application or ‘D’ to disable the application. Status may be the status of the application, which includes True if the application is currently enabled, otherwise False.

The mobile device 20 may utilize the Application ID, Application Name, Application Version, and Application Date from the Application List Module 210 for the User Role entry. Date of activation may be set to blank, Action may be set to enabled or disabled, and Status may be set to false.

The example system 10 may maintain a system log file that indicates the number of installed occurrences of each application across a fleet of mobile devices 20. The system log file may be useful for understanding field penetration when performing troubleshooting and software impact assessments. The remote computer 30 may dynamically maintain the Application Installation Log. Each entry in the Application Installation Log may represent a specific version of an application.

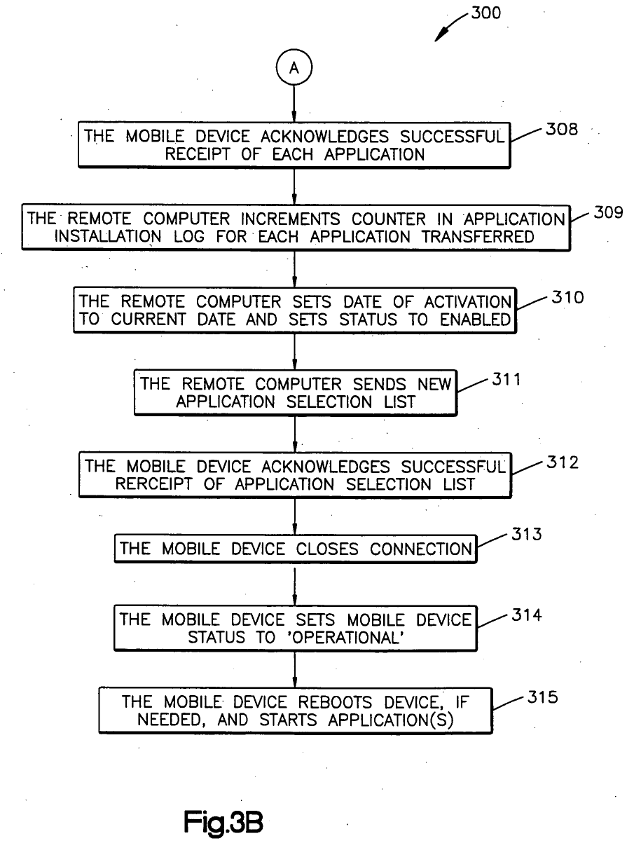

Once the application selection process is complete, the system 10 may enable the application software. A mobile device 20 may start the application selection process by initiating a connection to the remote computer 30. The mobile device 20 and the remote computer 30 may perform a sequence of message transfers throughout the enabling process, as described in the example of FIG. 3.

In step 301, the mobile device 20 of the system 10 initiates a connection with the remote computer 30. Following step 301, the system 10 proceeds to step 302. In step 302, the remote computer 30 requests a state of the mobile device 20. Following step 302, the system 10 proceeds to step 303. In step 303, the mobile device 20 responds to the remote computer 30 with a factory default state. Following step 303, the system 10 proceeds to step 304. In step 304, the remote computer 30 requests an application activation file from the mobile device 20. Following step 304, the system 10 proceeds to step 305. In step 305, the mobile device 20 sends an application activation file to the remote computer 30. Following step 305, the system 10 proceeds to step 306. In step 306, the remote computer 30 performs maintenance on the application activation file (i.e., remove applications that are no longer valid, etc.). Following step 306, the system 10 proceeds to step 307. In step 307, the remote computer 30 initiates a transfer of each application to be enabled by the mobile device 20. Following step 307, the system 10 proceeds to step 308. In step 308, the mobile device 20 acknowledges successful receipt of each application from the remote computer 30. Following step 308, the system 10 proceeds to step 309.

In step 309, the remote computer 30 increments a counter in the application installation log for each application transferred to the mobile device 20. Following step 309, the system 10 proceeds to step 310. In step 310, the remote computer 30 sets date of activation to the current date and sets status to enabled. Following step 310, the system 10 proceeds to step 311. In step 311, the remote computer 30 sends the new application selection list to the mobile device 20. Following step 311, the system 10 proceeds to step 312. In step 312, the mobile device 20 acknowledges successful receipt of application selection list from the remote computer 30. Following step 312, the system 10 proceeds to step 313.

In step 313, the mobile device 20 closes communication with the remote computer 30. Following step 314, the system 10 proceeds to step 314. In step 314, the mobile device 20 sets mobile device status to ‘operational’. Following step 314, the system 10 proceeds to step 315. In step 315, the mobile device 20 reboots, if needed, and starts the application(s). Steps 307-315 may be repeated for each application.

When an application is enabled, the remote computer 30 may check the Application Installation Log to see if the version number of the application exists in the log. If an entry is found, the installation counter is incremented. If no entry is found, a new entry is added for this version of the application and the installation counter is initialized to 1.

As new applications are developed and made available to the mobile devices 20, each mobile device may be able to activate these applications when the mobile device is in an operational state. The mobile device 20 should also allow currently installed applications to be disabled, in the event that the user of the device changes job tasks or a different user is assigned the device.

Enablement while the mobile device 20 is in an operational state may be similar to enablement while the mobile device is in the factory default state. However, the application disabling capability may also occur in the operational state.

When an application is disabled, the remote computer 30 may locate the version of the application in the Application Installation Log and decrement the installation counter. If the counter is decremented to zero, the application may no longer be installed on any mobile device 20 and the entry may be removed from the Application Installation Log.

An example system 10 in accordance with the present invention enables a mobile data acquisition device 20. The system 10 includes a software application for use with the mobile data acquisition device 20. The software application is located on a remote computer 30. The remote computer 30 transfers the software application from the remote computer to the mobile data acquisition device 20. The remote computer 30 installs and activates the software application for use by the mobile data acquisition device 20. The software application is determined by a user and replaces a factory default software application.

Another example system 10 in accordance with the present invention enables a software application. The system 10 includes a data acquisition device 20 and a remote computer 30. The data acquisition device 20 is used with the software application. The remote computer 30 transmits the software application from the remote computer to the data acquisition device 20. The remote computer 30 installs and activates the software application for use by the data acquisition device 20. The data acquisition device 20 has the capability of disabling the software application of the data acquisition device.

An example computer program product in accordance with the present invention enables a software application. The computer program product includes: a first instruction for initiating communication between a mobile device 20 and a remote computer 30; a second instruction for requesting the state of the mobile device 20 by the remote computer 30; a third instruction for responding to the remote computer 30 by the mobile device 20 with a factory default state message; a fourth instruction for initiating transfer of a software application from the remote computer 30 to the mobile device 20; and a fifth instruction for acknowledging receipt of the software application from the remote computer 30 by the mobile device 20 thereby enabling the software application at the mobile device.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, handheld computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for enabling a mobile data acquisition device, said system comprising:
a software application for use with the mobile data acquisition device, the software application being located on a remote computer,
the remote computer transferring the software application from the remote computer to the mobile data acquisition device,
the remote computer installing and activating the software application for use by the mobile data acquisition device, the software application being determined by a user and replacing a factory default software application.

2. The system as set forth in claim 1 wherein the remote computer enables a first set of applications for the mobile data acquisition device, the first set of applications being defined by a first User Role.

3. The system as set forth in claim 2 wherein the remote computer disables the first set of applications and enables a second set of applications for the mobile data acquisition device, the second set of applications being defined by a second User Role.

4. The system as set forth in claim 1 wherein the mobile data acquisition device includes a User Role selection module, an application list module, and an application selection module.

5. The system as set forth in claim 4 wherein the User Role selection module displays a list of User Roles for the user.

6. The system as set forth in claim 4 wherein the application list module maintains a list of available software applications for the mobile data acquisition device.

7. The system as set forth in claim 4 wherein the application selection module maintains a list of enabled software applications for the mobile data acquisition devices.

8. The system as set forth in claim 1 wherein the mobile data acquisition device disables a software application no longer needed by the mobile data acquisition device.

9. The system as set forth in claim 1 wherein the remote computer maintains an application installation log for determining software applications enabled at a given time.

10. The system as set forth in claim 1 wherein the remote computer requests an application activation file from the mobile data acquisition device.

11. A system for enabling a software application, said system comprising:
a data acquisition device for use with the software application;
a remote computer for transmitting the software application from said remote computer to said data acquisition device,
said remote computer installing and activating the software application for use by said data acquisition device, said data acquisition device having the capability of disabling a software application of said data acquisition device.

12. The system as set forth in claim 11 wherein said remote computer initiates transfer of the software application subsequent to said data acquisition device sending an application activation file to said remote computer.

13. The system as set forth in claim 11 wherein said remote computer removes invalid applications from an application activation file.

14. The system as set forth in claim 11 wherein said data acquisition device acknowledges receipt of the software application from the remote computer.

15. A computer program product for enabling a software application, said computer program product comprising:
a first instruction for initiating communication between a mobile device and a remote computer;
a second instruction for requesting the state of the mobile device by the remote computer;
a third instruction for responding to the remote computer by the mobile device with a factory default state message;
a fourth instruction for initiating transfer of a software application from the remote computer to the mobile device; and
a fifth instruction for acknowledging receipt of the software application from the remote computer by the mobile device thereby enabling the software application at the mobile device.

16. The computer program product as set forth in claim 15 further including a sixth instruction for changing a status of the mobile device from a “factory default” state to an “operational” state.

17. The computer program product as set forth in claim 15 further including a sixth instruction for rebooting the mobile device.

18. The computer program product as set forth in claim 15 further including a sixth instruction for running the software application on the mobile device.

19. The computer program product as set forth in claim 15 further including a sixth instruction for sending an application activation file from the mobile device to the remote computer.

20. The computer program product as set forth in claim 15 further including a sixth instruction for ceasing communication between the mobile device and the remote computer.
